(19) United States
(12) Patent Application Publication
(10) Pub. No.: US 2005/0117610 A1
(43) Pub. Date: Jun. 2, 2005

(54) Compressor, decompressor, data block and resource management method

(75) Inventors: Emmanuelle Chevallier, Orgeval (FR); Jean Farineau, Levallois Perret (FR); Nicolas Chuberre, Pibrac (FR); Cecile Faure, Toulouse (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL, Paris (FR)

(21) Appl. No.: 10/487,272

(22) PCT Filed: Jun. 28, 2002
(86) PCT No.: PCT/FR02/02252

(30) Foreign Application Priority Data
Aug. 23, 2001 (FR) 01/11048

(51) Int. Cl. H04J 3/00

(52) U.S. Cl. 370/521; 375/240

(57) ABSTRACT

The invention relates to a compressor of data from data frames. According to the invention, the compressor detects “active” elements that vary from one frame to another and transmits only the “active” elements in a data block. This block also contains a state code locating this “active” data in the original frame, in order to be able to reconstitute it. The invention also relates to a data decompressor, a data block containing a data group compressed in accordance with the invention, and a bandwidth resource management method. Particular application in a satellite telecommunication system.

The field of the invention is that of telecommunications. To be more precise, the present invention relates to a data compression device for compressing a set of current data input frames whose structure is defined by a plurality of time slots, a first group of time slots being such that each is decomposed into a plurality of elements carrying respective communication channels.

The invention also relates to a data decompression device, a data block comprising a compressed data group, and a method of managing bandwidth resources between traffic stations in a telecommunication system. This system can in particular comprise a telecommunication system with dynamic allocation of resources on demand incorporating transmission via satellite. The satellite channels are time division multiple access (TDMA) channels using time division multiplexing to allocate resources.

FIG. 1 shows a prior art satellite transmission network for data. This network comprises in particular a satellite 11 and a communication resource management center 10 that communicates by radio with the satellite 11. Traffic stations 12, 13 comprising terminals operating in TDMA mode or SCPC mode also communicate with the satellite 11 and are connected to public or private telephone switching centers 14, 15, which are generally referred to as a public switching telephone network (PSTN) in the case of a terrestrial network. Each PSTN 14, 15 is connected to a plurality of subscribers 16, 17.

Communications between subscribers 16 and subscribers 17 connected to different traffic stations are set up by the management center 10, which allocates transmission frequencies dynamically (in the SCPC operating mode) or time slots of a time frame (in the TDMA operating mode), as a function of connection requests from these subscribers. Thanks to this dynamic allocation of resources, this demand assignment multiple access (DAMA) mode of operation optimizes the use of satellite resources.

Thus satellite resources are assigned on demand; when a subscriber requests call set-up, if his request can be accepted, a satellite channel is set up between the outgoing traffic station to which the calling subscriber is connected and an incoming traffic station to which the called subscriber is connected. At the end of the call, the management center 10 is informed of the releasing of the resources assigned in this way.

The center 10 not only manages satellite frequencies but also provides modems for setting up telephone calls in the outgoing and incoming traffic stations.

In general terms, operation is as follows:

In the SCPC mode of operation, the management center 10 assigns satellite frequencies when it detects line seizure by a subscriber 16 or 17, that line seizure taking the form of an analog signal at a particular frequency or a digital signal (a line seizure signaling bit or word) transmitted by the subscriber to the management center 10 via the PSTN 12 or 13. The traffic stations 14 and 15 format signals sent by the subscribers in a form suitable for transmission to the management center 10 via a modem.

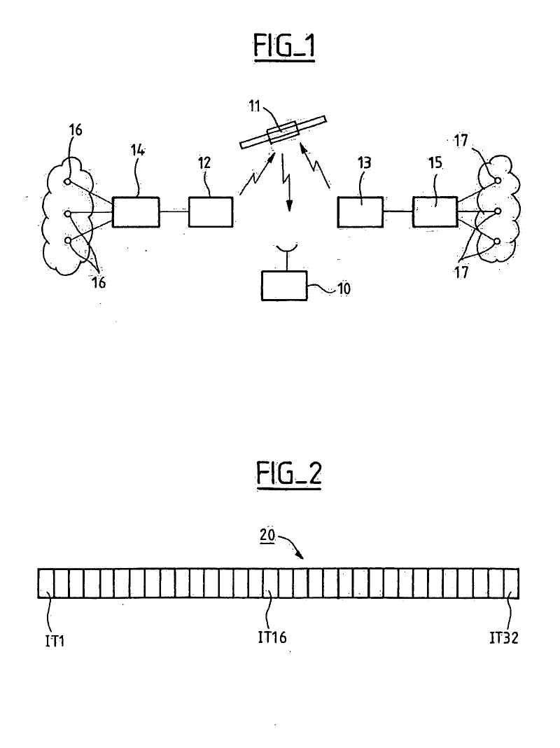

FIG. 2 shows one example of a frame 20 of the above kind. The frame 20 comprises 32 time slots IT1 to IT32 each comprising eight bits, the first time slot IT1 being dedicated to synchronization and to specific signaling, the time slot IT16 carrying line signaling from the PSTN, and the other time slots being reserved for the transmission of payload data (dialing, voice data, etc) for one transmission direction sent by the subscribers. These “subscribers” are telephones, private automatic branch exchanges, or a public telephone network, for example. Each frame has a duration of 125 μs and provides a call bit rate of 2 Mbps.

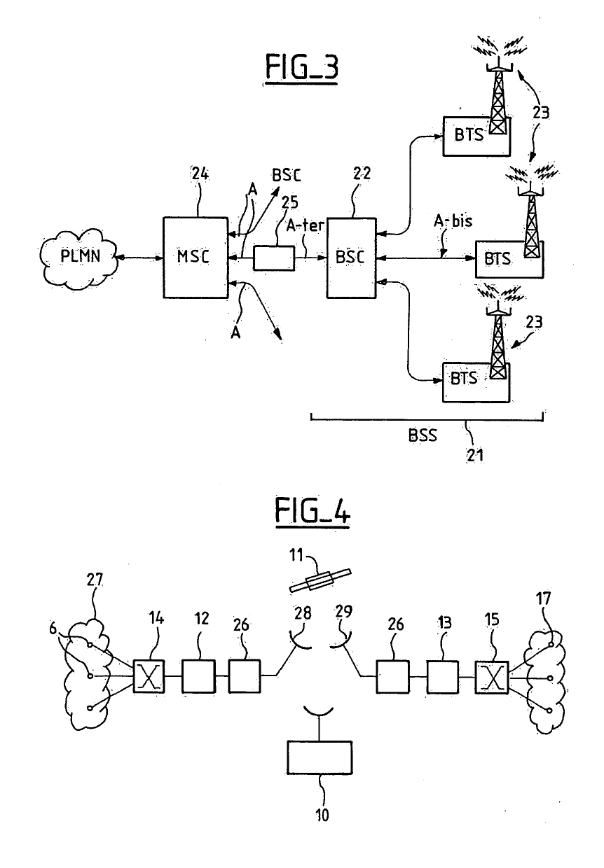

FIG. 3 shows diagrammatically a portion of the infrastructure of a Global System for Mobile communications (GSM) network. It shows the radio subsystem 21 constituting the base station system (BSS) for managing radio transceiver relay stations. A BSS comprises a base station controller (BSC) 22 and one or more cells and therefore one or more base transceiver stations (BTS) 23. The BSC manages the radio resources of the associated BTS stations and operation and maintenance functions of the base stations. It handles autonomously intercellular transfer (handover) of mobile stations in its coverage area. Furthermore, as shown in FIG. 3, the BSC comprises two standardized interfaces, an A-bis interface with the base stations 23 and an A-ter interface connecting the BSC to a mobile switching center (MSC) 24 via a transcoder/rate adaptor unit (TRAU) 25. The function of the TRAU is to convert compressed voice at 13 kbps to digitized voice at 64 kbps in order to render the voice channels compatible with the MSC. Accordingly, MSC-BSC coupling is operative at a standard bit rate of 64 kbps on the MSC side and 16 kbps on the BSC side, this bit rate comprising the compressed voice bit rate of 13 kbps plus an overhead consisting of framing and padding bits. The interface between the MSC and the TRAU is called the A interface and the interface between the TRAU and the BSC is called the A-ter interface.

The TRAU 25 is compatible with the different types of signal transmitted at the A-ter interface and converts all these signal types to a bit rate of 64 kbps. The signals concerned are essentially full-rate voice at 16 kbps, half-rate voice at 8 kbps and signaling at 64 kbps or 16 kbps.

The MSC is the interface between the BSS radio subsystem and a cable network such as a public land mobile network (PLMN) 27. The MSC carries out all the operations necessary for managing communication with mobile terminals. To provide radio coverage of a territory, a mobile network switch drives a set of transmitters, which explains the inclusion in FIG. 3 of a plurality of A-ter interfaces with other BSS.

The A-bis interface providing the link between the BTS and the BSC of the system is set up via a synchronous interface E1 using G.703 type frames (referred to herein as E1 frames). A fraction of each frame carries payload data.

It will be noted that expanding a GSM network via satellite obtained by an expansion via satellite, as proposed hereinafter in particular, is effected interchangeably at the level of the A-bis interface, the A-ter interface, or possibly the A interface.

Whichever interface is selected for the expansion via satellite, the number of transmission channels used (time slots or subdivisions of these time slots) is fixed and depends essentially on the physical configuration of the BSS (number of BTS, number of carriers). On the other hand, only some of these transmission channels are active at any given time; the number of active channels depends on the signaling to be conveyed, the number of calls set up, and the inherently half duplex nature of any dialog between parties.

To minimize the bandwidth required for satellite communication in the case of the expansion, the telecommunication system considered for the expansion operates in the DAMA mode, which means that the satellite resources devoted to the connection at any given time depend on the bit rate of the data to be transmitted, i.e. on the number of active channels within the frames to be transmitted.

The DAMA equipment operates in two different modes:
either this equipment interprets the signaling (for example SS7 signaling) to detect activation of new transmission channels, in order to adapt the assignment of transmission resources accordingly (variation of the band assigned for a given connection); in this case, the signaling is not the standard signaling, and having the DAMA equipment operate as a function of the signaling conveyed would be complex and would depend on the equipment supplier, since the A-bis interface between the BSC and the BTS is not standardized,
or this equipment uses an Ethernet, ATM or even frame relay type interface. In this case, the DAMA process operates in a simpler way, since it takes the average bit rate present on the transmission channel as the basis for adjusting the assignment of transmission resources. Note that in the present context the bit rate does not vary, because it is independent of the activity of the channels to be transmitted via the satellite, and is typically 8×16 kbps per carrier transmitted by the BTS.

This second type of DAMA operation, based on measuring or detecting bit rate variations, is preferred, since it avoids having to interpret the signaling conveyed over the expanded interface to vary the satellite band assignments. However, because the interface to be expanded is not directly compatible with the transmission equipment of the system, an intermediate device known as a transcoder is used.

There are two requirements in respect of this transcoder: firstly, it must be able to extract from synchronous frames the payload data corresponding to active transmission channels, and only those channels, and then encapsulate them in Ethernet frames, IP packets, or ATM cells. These elements are applied to the transmission equipment of the BSC, which can therefore offer the benefit of DAMA operation.

Secondly, the transcoder must also be able to re-establish synchronism at the end of the transmission system, given that the process introduced, which is based on extracting payload data from synchronous frames and encapsulation, totally destroys the original sequence of the frames. Consequently, the transcoder must reconstitute the frames in exactly the same form as at the source.

To provide the benefit of the DAMA functions offered by the transmission equipments, the E1 frames must be converted into Ethernet frames, IP packets, or an ATM data stream. Prior art transcoders capable of E1-Ethernet, E1-IP or E1-ATM adaptation do not compress the E1 frames to be transmitted. Whether the E1 frames carry valid data or not, the resulting bit rate is constant; these transcoders are therefore unable to reduce the satellite bandwidth as a function of the effective activity of the transmission channels of the GSM network; the reason why the transcoders take no account of the real activity of these transmitted channels relates to the fact that they constitute physical interface conversion solutions and do not analyze the content of the frame.

Thus one particular object of the present invention is to remove the drawbacks cited hereinabove, especially in a DAMA mode transmission system, although this is not limiting on the invention.

A more general object of the invention is to provide a compression device that optimizes the frequency band for the transmission of the data to be transmitted.

To this end, the invention consists in a data compression device for compressing a set of current data frames of a data stream, these frames having a structure defined by a plurality of time slots, a first group of time slots being such that each is decomposed into a plurality of elements carrying respective communication channels,
characterized in that said compression device comprises:
means for transmitting a reference pattern comprising the N frames preceding the set of current frames, where N is an integer greater than or equal to 1,
means for analyzing the active or static state of at least one channel contained in an analysis window of the current frames, the active, respectively static, state of this channel being assigned to it if the comparison of the content of this channel in the N bits compared between the N frames of a reference pattern with the corresponding N bits of the N frames of the analysis window indicates a variation of content for at least one of the bits, respectively a stability of the content for all of the N bits,
extraction means for extracting the content of the active channels from the analysis window as a function of the active states of the elements supplied by said analysis means,
location means for supplying indications of the locations of said active and static elements in the current frame as a function of active states of the elements supplied by said analysis means, and
grouping means for grouping an identifier of the current block, the content of the active elements, and their respective locations within a data block to be transmitted.

Thus the compression device of the invention achieves a significant improvement in terms of transmission bandwidth. This bandwidth saving can be as high as 50%, depending on the rate of filling of the input data frames, i.e. the number of active elements. To be more specific, in the context of a satellite telecommunication system linking traffic stations operating in a DAMA mode in which the compression device of the present invention is implemented, the bandwidth saving would be a function of the number of traffic stations, as explained hereinafter. In accordance with the spirit of the invention as defined above, the output stream of the compression device has a variable bit rate that is a function of the number of active elements analyzed. By applying this stream to DAMA mode transmission equipment, the bandwidth resources of the connection set up for the equipment are adopted virtually in real time as a function of the actual requirements of the connection.

In one embodiment of the invention said analysis window comprises first memory means for storing N frames preceding the current analysis window forming the reference pattern.

In one embodiment of the invention said analysis window comprises second memory means for storing current frames forming the analysis window.

In one embodiment of the invention said analysis window has a length of L*N frames, where L≧1, so that the bits are grouped into blocks of N bits thereby forming L blocks of N bits and for each spatially corresponding bit within the L block in succession, the repetition of the same content leads to an inactivity decision in respect of the block of N bits.

In one embodiment of the invention said analysis window comprises frame identification means for supplying an identifier specific to each compressed frame.

In one embodiment of the invention said location means comprise generation means for generating a state code signifying respective states of said elements of the input frames.

In one embodiment of the invention said analysis means comprise comparison means for comparing the content of the analysis window with that of the reference pattern, detection means for detecting state variations as a function of said comparison, and determination means for determining the active or static state of each element, respectively the N bit blocks.

In one embodiment of the invention the determination means comprise third storage means for storing a number L corresponding to the number of N-width bit blocks to be considered before an element is identified as changing from the active state to the static state.

In one embodiment of the invention the device of the invention comprises fourth storage means for storing a plurality of data blocks before sending.

In one embodiment of the invention said grouping means comprise a padding data manager for managing data to be transmitted in complementary fashion in the block relative to the data contained in said first group of time slots.

In one embodiment of the invention the device of the invention comprises a plurality of outputs for transmitting data blocks, each output offering a predetermined bit rote, the device being pre-programmed to direct data blocks selectively to the outputs according to their respective bit rate saturation level.

In one embodiment of the invention the device of the invention comprises a fixed bit rate first output and a variable bit rate output for receiving the data block.

In one embodiment of the invention the device of the invention comprises at least three outputs, a fixed bit rate first output, a fixed bit rate second output that is activated as soon as the bit rate exceeds the capacity of that offered at the first output, and a third output that is activated in place of the second output as soon as the capacity available at the first and second outputs appears insufficient in turn, alternate activation of the first and second outputs increasing, respectively decreasing, in predetermined steps the capacity assigned to the connection to which the compression device is connected as a function of current requirements.

The present invention also provides a data block comprising a data group compressed from a set of data frames having a structure defined by a plurality of time slots, a first group of time slots being such that each is decomposed into a plurality of elements each carrying a respective communication channel, characterized in that the active state, respectively the static state, of this channel is allocated to it if the comparison of the content of this channel in the N bits compared between the N frames of a reference pattern for the corresponding N bits of N frames indicates a variation of content for at least one of the bits, respectively, a stability of content for all the N bits, the compressed data group comprises the content of the channels active of the frames, and in that the block further comprises an identifier specific to the block and indications of the locations of said active elements in the frames.

In one embodiment said location indications comprise a state code representative of the position of said active elements within the frames.

In one embodiment the frame identifier is a frame number modulo the capacity of frame counting means of a data compression device according to the invention.

In one embodiment the group of data also includes complementary data to be transmitted in complementary manner in the block relative to the data contained in said first group of time slots.

In one embodiment said complementary data comprises padding data for obtaining a safety margin when assigning transmission resources to the connection concerned and/or payload data repeating pertinent data contained in said first group of time slots.

In one embodiment the payload data belongs to the group comprising header data, current frame identifier, indications of the locations of said active elements in the current frame, and state code.

In one embodiment the compressed data group is followed adjacently by a delimitation field marking the end of the compressed data group.

The present invention also provides a data decompression device for decompressing a compressed data block, said data block comprising a data group compressed from a set of current data frames having a structure defined by a plurality of time slots, a first group of time slots being such that each is decomposed into a plurality of elements carrying respective communication channels, characterized in that it comprises fourth storage means for storing a received reference pattern comprising the N frames preceding the current compressed data block, where N≧1,
and it being understood that the active, respectively static, state of this channel is assigned to it if the comparison of the content of this channel in the N bits compared between the N frames of the reference pattern with the corresponding N bits of the N frames of the analysis window indicates a variation of content for at least one of the bits, respectively a stability of content for all of the N bits, the decompressor comprises:
detection means for detecting indications of the locations of the active elements of the data group in a group of data of the block,
fifth storage means for storing said active element location indications,
insertion means for inserting the detected static and active elements as a function of their respective indicated location, so as to form the current frames.

The present invention further consists in a method of managing bandwidth resources in a telecommunication system transmitting data blocks between traffic stations via satellite, such a data block comprising a data group compressed from a set of data frames having a structure defined by a plurality of time slots, a first group of time slots being such that each is decomposed into a plurality of elements carrying respective communication channels, and said system comprising a management center for managing said resources, characterized in that said system being provided, for at least one station, with analysis means for analyzing the active or static state of N bits contained in an analysis window of the current frames, where N=1, the active, respectively static, state of this channel being assigned to it if the comparison of the content of this channel in the N bits compared between the N frames of a reference pattern with the corresponding N bits of the N frames of the analysis window indicates a variation of content for at least one of the bits, respectively a stability of content for all the N bits, the method comprises, at the management center, the steps of:
receiving information representative of the analyzed active elements of at least one data block, and
assigning resources for the station as a function of said information.

In one embodiment of the invention the information transmitted representative of the active elements originates from a request for resources sent from said at least one station to the management center, whereby the transmission resources of the station are varied each time that an element goes from the active state to the static state, or vice-versa.

In one embodiment of the invention the step of receiving information representative of the analyzed active elements follows a step of detecting active elements on the transmission link of the station in the system.

In one embodiment of the invention the step of assigning resources consists in determining a data block size and/or a transmission period conferred on the station on the link that is a function of said information and allows transmission of at least the active elements.

In one embodiment, the step of assigning resources for the station is effected as a function of said information, on the basis of which a supplementary margin between the number of elements and the magnitude of the resources assigned to each connection of the stations of the system is opportunely taken into account. This takes account of the fact that resources were assigned cyclically, generally as a function of statistics established from the preceding assignment cycle relating to the number of active elements. This cycle routinely takes a second or several seconds, during which period the number of active elements can increase significantly for a given connection. The margin established when assigning resources is intended to prevent all risk of overflow, where the number of active elements would exceed the quota of transmission resources assigned to the connection concerned. Because this margin reduces the saving achieved by the DAMA function, a compromise is arrived at between the risk of overshoot and the sum of the resources assigned to all of the connections.

In one embodiment, said system comprises a complementary data manager adapted to add complementary data to the connection set up for said at least one station, thereby providing it with a resource margin.

Other features and advantages of the invention will appear in the course of the following description of embodiments of the invention, provided by way of illustrative and non-limiting example, and from the appended drawings, in which:

FIG. 1, already described, depicts a prior art satellite transmission network for data,

FIG. 2, already described, depicts a frame fed from a switching center to a traffic station in the prior art network,

FIG. 3, already described, depicts diagrammatically a portion of the infrastructure of a GSM network comprising the radio subsystem,

FIG. 4 depicts a first embodiment of a satellite transmission system for data conforming to the invention,

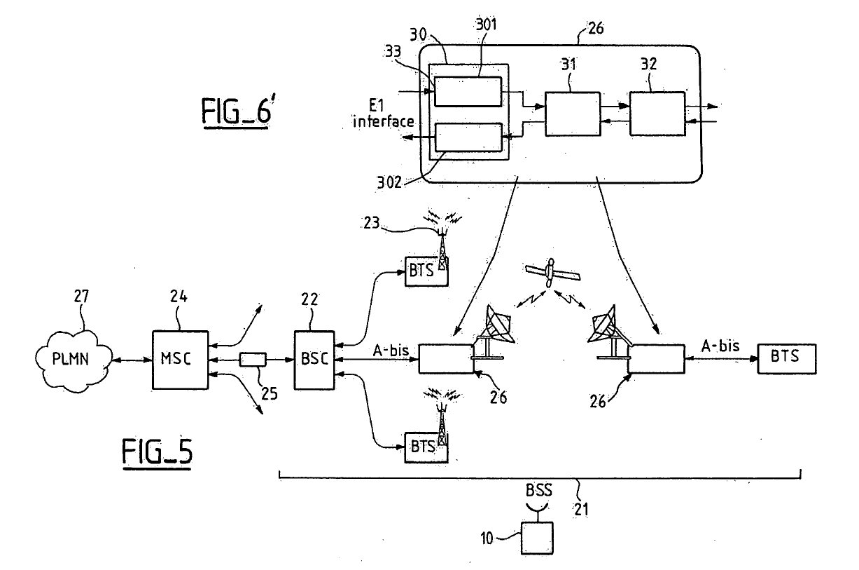

FIG. 5 depicts the disposition of a satellite signal transceiver device within a GSM cellular network infrastructure,

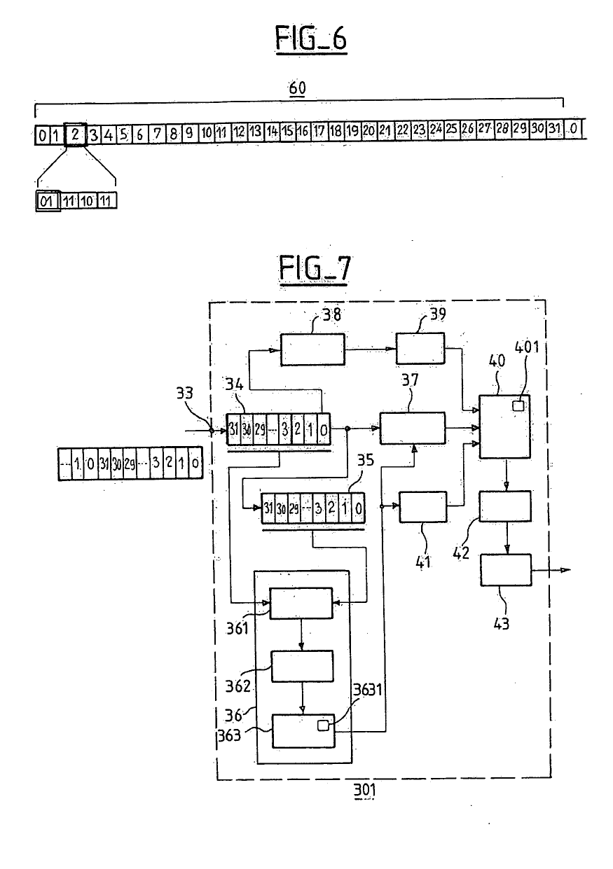

FIG. 6 depicts the frame structure to be transmitted over the A-bis or A-ter interface,

FIG. 6′ depicts a signal transceiver device comprising a compressor and a decompressor conforming to one embodiment of the invention described in the priority patent application filed by the applicant referenced FR No. 01 11 048, the content of which is included in the present application, hereafter called the priority application [sic],

FIG. 7 depicts a frame compression device conforming to one embodiment of the invention of the priority application,

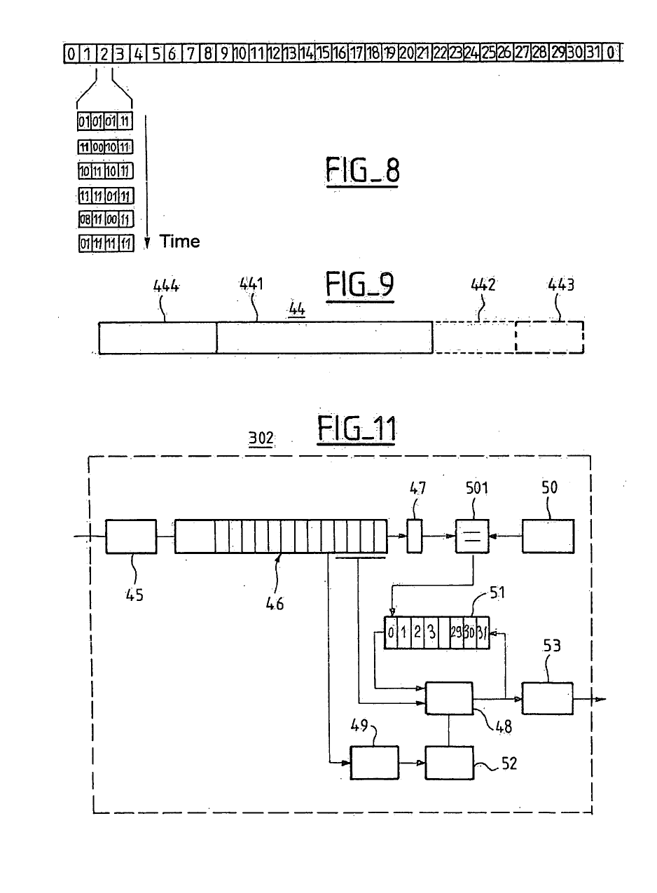

FIG. 8 depicts the comparison principle of one embodiment of the invention of the priority application, for a given time slot of its content over a plurality of consecutive frames,

FIG. 9 depicts the structure of a data block delivered by the reconstitution unit of the compressor in one embodiment of the invention of the priority application,

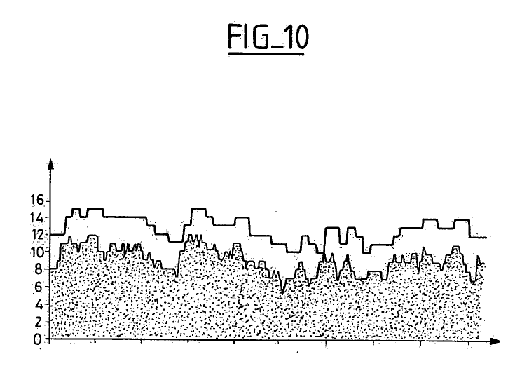

FIG. 10 depicts traffic variations at a traffic station for 16 simultaneous voice calls,

FIG. 11 depicts a data block decompression device of one embodiment of the invention of the priority application,

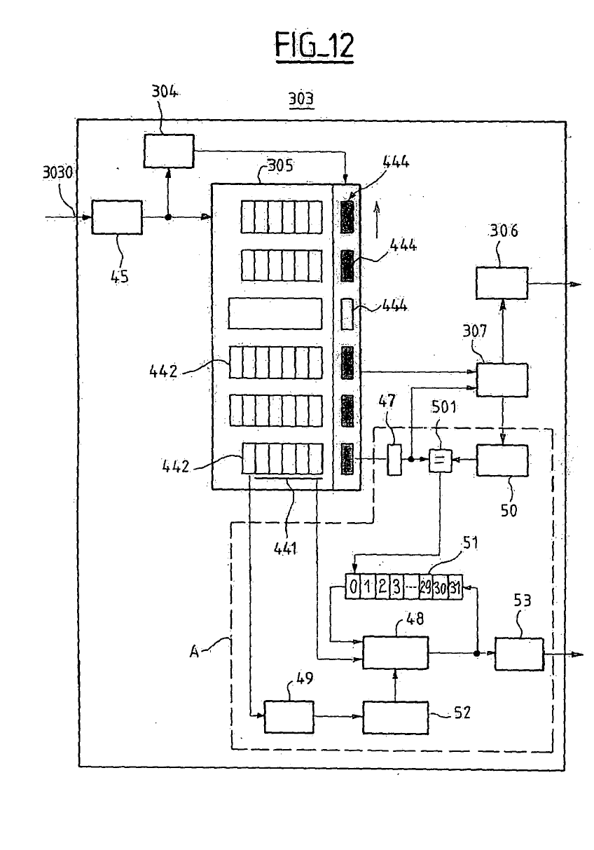

FIG. 12 shows a variant of the FIG. 11 data block decompression device,

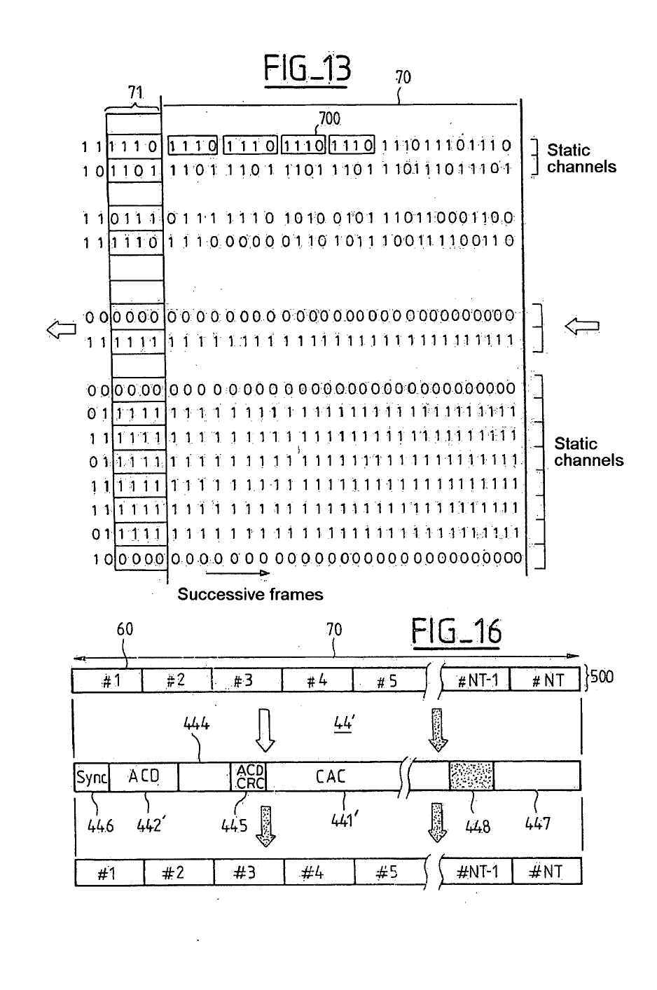

FIG. 13 depicts diagrammatically the theory of the compression method according to the present invention,

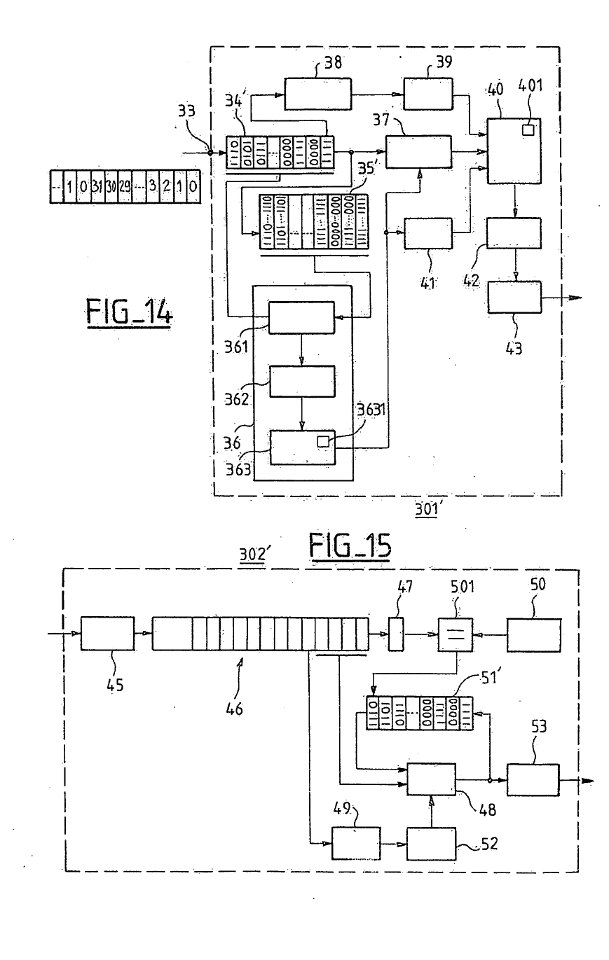

FIG. 14 depicts one embodiment of the compressor according to the invention,

FIG. 15 depicts one embodiment of the decompressor according to the invention,

FIG. 16 depicts one embodiment of a compressed frame or compressed data block according to the invention,

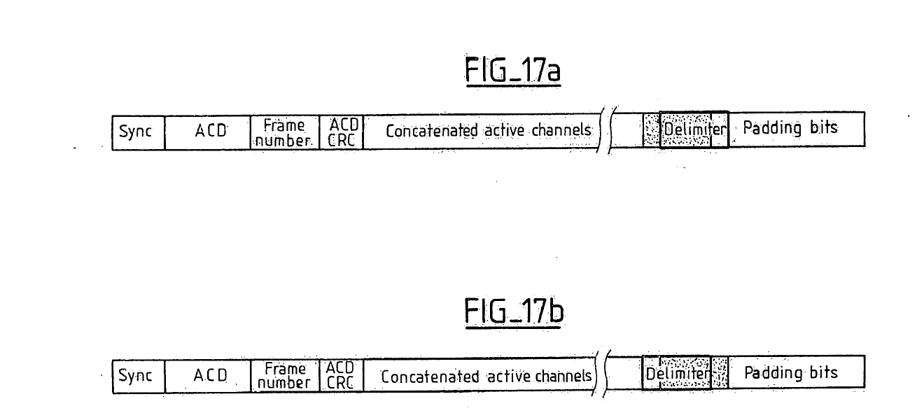

FIGS. 17a and 17b represent configurations of production of errors occurring over the compressed frame [sic],

In the present application, the same reference numbers denote items having identical or equivalent functions.

It will be noted that, notwithstanding the integration of the content of the priority application because of its high relevance, the invention of the present application is described only from FIG. 13 onwards.

FIG. 4 shows again the components of the telecommunication system from FIG. 1. The system comprises two telephone switching centers 14, 15 each connected to a plurality of subscribers 16, 17 and to a traffic station 12, 13, respectively. The switching centers supply frames at 2 Mbps, as shown in FIG. 2 and described in more detail later with reference to FIG. 5 and FIG. 6. Each traffic station 12, 13 is connected to a signal transceiver device 26 connected to a respective satellite antenna 28, 29.

FIG. 5 depicts the disposition of the device 26 within a GSM cellular network infrastructure. Note that the device 26 can be included in the BSC 22 or even constitute part of the A-ter interface.

The device 26 is shown in more detail in FIG. 6′. It comprises a first input/output pair connected to the interface E1 connected to the BSC 22. This input/output pair is connected to a frame compression/decompression device 30 to be described in more detail hereinafter. This device is also connected to a modem 31 for full-duplex TDMA transmission/reception of time slots. The modem 31 is connected to the inputs/outputs of a signal radio processing unit 32 that is connected to the respective antenna 28, 29.

The system further comprises a resource management center 10 and a satellite 11 through which calls between stations pass. This is known in the art.

A first input of the device 26 is connected to a first input of the first pair of the device 30 connected to an input of a frame compression device 301 and supplying an output signal to the modem 31 at a first output of the device 30; a second input of the device 30 connects the modem to a frame decompression device 302 of the device 30 supplying a decompressed frames signal to the BSC at an output of the device 26. For conciseness, the frame compression device is referred to hereinafter as a compressor and the frame decompression device is referred to hereinafter as a decompressor.

The compressor 301 compresses frames to be transmitted and adapts the format of the resulting data blocks to the transmit mode interface offered by the modem 31, namely an Ethernet, IP or ATM interface.

The decompressor 302 handles adaptation at the receive mode interface offered by the modem 31 (which is generally identical to that on the transmit modem side), and reconstitutes the frames in the form in which they were applied to the input of the compressor.

FIG. 6 depicts the typical structure of a frame 60 to be transmitted over the A-bis or A-ter interface of GSM cellular networks. It will be noted that the present invention is not limited to this kind of interface and encompasses any other type of interface, in particular those relating to non-cellular networks.

Each frame comprises a fixed number of time slots, in the present context 32 time slots for the E1 frames in accordance with ITU-T Recommendations G.703/G.704, each time slot carrying one byte. The time slot 0 is reserved for synchronizing the transmitted frames, with a view to synchronizing the received frames at the destination equipment. The frame frequency is generally 8 kHz, catering for 31 channels, at the rate of one 64 kHz channel per slot.

In the present context of expanding cellular networks via satellite, each byte is made up as follows:
each byte comprises four nibbles and each nibble carries a 16 kbps channel; this applies in particular to transmission of the 16 kbps compressed channel over the A-bis and A-ter interface;
or each byte transports eight half-rate compressed voice channels, in which case each bit corresponds to one voice channel,
or the byte is not subdivided, which is the case for transmitting data using the Global Packet Radio Service (GPRS), providing 64 kbps user data channels, and for transmitting signaling;
or other forms may exist: for example, two channels at 32 kbps, one channel at 32 kbps, and two channels at 16 kbps, etc.

FIG. 7 depicts the compressor 301 in one embodiment of the invention of the priority application.

The operation of the compressor is described hereinafter:

Firstly, it extracts the content of each frame. To this end, it synchronizes on the reference time slot 0 and extracts the data present in subsequent time slots.

It then compresses the extracted data within the frame. This process depends on the structure of each time slot. Two approaches are envisaged:
either the structure of the frame (the number of time slots used and the position of those time slots within the frame) and the structure of each time slot are defined by configuration: four 16 kbps channels (nibble structure), then eight 8 kbps channels (bit structure), then one 64 kbps channel, etc.,
or the compressor itself determines the structure of each time slot by a learning process, statistically analyzing the evolution of each bit in relation to the evolution of the adjacent bits in order to identify correlations in the changes of state; it is widely accepted that the configuration of the structure of the transmitted frames does not generally change, and that a learning process can therefore be used to avoid having to configure the compressor as a function of its use.

FIG. 7 depicts the frame compression device 301 of one embodiment of the invention of the priority application. The principle of compression applied by the compressor is as follows: the structure of the time slot being known, the compressor compares the content of the slot of the current frame with the content of the same slot in preceding frames. FIG. 8 depicts this principle diagrammatically, showing the principle of comparison for the time slot 2 over a temporal length of six frames.

The data frames enter at the input 33 of the compressor 301, which is connected to the input of the first input/output pair of the device 26. This input 33 is connected to a first in first out (FIFO) frame buffer 34 that stores the current frame. This buffer 34 has its output connected to an input of a memory 35 for storing the frame preceding the current frame present in the buffer 34. The buffer 34 also has its output connected to an input of an analysis unit 36, which input is connected in the unit 36 to a comparison unit 361. Thus this unit 361 is adapted to compare the current frame with the frame preceding that which it receives at a second input connected to an output of the memory 35. The analysis unit 36 further comprises a unit 362 for detecting state variations, connected at its input to the output of the comparison unit 361, and a state machine 363, connected to the output of the detection unit 362 and adapted to determine the active or static state of each of the elements transmitted (for example each of the nibbles transmitted), as explained hereinafter. The buffer 34 also supplies the output of the current frame to the input of an active element extractor 37 whose input is connected to the output of the state machine 363 of the analysis unit. The state machine is connected at its output in parallel with a state encoder 41 adapted to provide compact codes for identifying the position of the active elements, this being effected either systematically or on detection of a change in the activity state of constituent elements of the frame. Finally, the buffer 34 is connected at its output to the input of a frame synchronization unit 38 whose output is connected to the input of a frame counter 39. This counter 39 supplies a number specific to the current frame to a first input of a data grouping unit 40 for constructing data blocks grouping data that is specific to the current frame. The number supplied by the counter 39 identifies the current frame. A second input of the grouping unit 40 is connected to the output of the extractor 37 and a third input is connected to the output of the encoder 41.

The grouping unit 40 constructs a data block using a method to be described in detail hereinafter and supplies the output of that block to an output buffer 42. A plurality of blocks are preferably concatenated in this buffer 42 before they are transmitted to a physical output interface 43 of the compressor 301 handling adaptation to the type of interface used for the connection to the transmit modem 31 (Ethernet, IP or ATM).

The compression method applied by the compressor includes the following steps:

The analysis unit 36 analyzes the content variations on the basis of the structure of the frame established by configuration in the example described (for example, nibble by nibble for a frame structured in nibbles), and detects state variations. This is done in the analysis unit, by having the comparison unit compare each nibble with its counterpart in at least the preceding frame, the result of the comparison being supplied to the detection unit 362, which detects and supplies activity states (active or static) to the machine 363, according to whether the state of the nibble has varied or not. When a nibble has not varied a fixed number of times, for example three times (the number of times can be much greater, and is configured in the state machine 363), the state machine 363 transmits to the unit 40, via the state encoder 41, the fact that the content of the nibble concerned is no longer being updated; the nibble is then considered to be in the static state. The compressor then stops transmitting the nibble concerned.

Conversely, as soon as a nibble that has been detected as being static changes state, transmission of its content is resumed without delay, the state machine transmitting a compact nibble state activation code to the unit 40 via the state encoder.

The codes that are transmitted to the unit 40 are representative of state variations of the elements (in this example the nibbles) and depend on the structure of those elements. According to one convention (which can obviously be reversed or modified), within a string of bits representing the state of the elements transmitted, a 1 signals that an element is active and a 0 signals that an element is static; for example, for a set of two consecutive time slots each transporting four nibbles, the following code combination could be obtained: 1010 1111, which is AF in hexadecimal. This sequence is representative of six active nibbles and two inactive nibbles (those assigned the code 0). The state change indication code is transmitted without delay, as soon as an element of the frame changes from the static state to the active state.

To avoid overloading the signaling frames transmitted on a change of state, a time delay is applied to the indications of one or more elements changing from the active state to the static state. The compressor uses a preprogrammed memory 3631 of the state machine 363 that contains a minimum of three frames (for example) to verify that the element concerned is identical in all three frames, but the buffer 42 of the compressor additionally retains at least N frames relative to the preceding change of state indication; this spaces out the change of state signaling and prevents the connection from being overloaded.

Conversely, the state machine is programmed to transmit the frame state change code immediately an element changes from the static state to the active state.

The frame state change code, or state code, as it is otherwise referred to, includes all the state codes of the elements carried by the frame, but only for the time slots that are used; these state codes are generated by the method defined hereinabove.

For example, for a frame used to transport two time slots, the code 00AF delivered by the encoder signifies that all the elements of the first time slot are static and that those of the second time slot are active, except for the nibbles 2 and 4 (above example 1010 1111). In this way, the state change code, which is referred to hereinafter as the state code, indicates the location of the active elements of the frame. This state code is supplied by the encoder 41 based on the state information at the output of the state machine.

Because the nibbles can therefore have two stable mutually exclusive states, respectively static and active, the grouping unit transmits only the nibbles that have been signaled to it as active, adding padding bits to complete the data block as a function of the constraints of the interface used. These padding bits are managed by a padding bit manager 401 internal to the grouping unit. These padding bits are explained in more detail hereinafter. It will be noted that, instead of padding information of no utility, it is possible to use this space in the frame to repeat data that is critical to efficient reconstitution of the frames, such as the state code or the frame number.

FIG. 9 shows the structure of a data block 44 delivered by the grouping unit 40 of the compressor. The block 44 comprises a compressed data block 441 containing the nibbles to be transmitted and a state code of the current frame, for example 00AF. That state code is representative of the position of the active elements within the frame concerned.

To signal a change of state to the decompression device at the other end of the transmission system (this decompression device is described in more detail hereinafter), by means of the encoder 41 or the unit 40, the compressor adds to the state code of the current frame, for example 00AF, a specific code 443 signaling the presence of a state code 442 within the block, which signifies that the block of data transmitted corresponds to a change of state. Alternatively, no specific codes as specified above are added to accompany the state code of the current frame, but instead the decompressor detects the addition of the state code by analyzing the length of the received data block. As soon as the block has a different length, the decompressor deduces that a state code is present at the end of the block.

Additionally, a frame number 444 is added to the head of the compressed data block to guarantee synchronization of data decompression and processing of data blocks lost in the transmission system. This frame number is counted modulo the capacity of the counter used for this purpose (for example 8 bits or 16 bits).

The data block constructed in this way is encapsulated in the Ethernet frame, the IP packet or the ATM cell, depending on the transmission mode adopted.

To reduce the overhead associated with encapsulation, a plurality of blocks are preferably concatenated in the buffer 42 before encapsulation.

The output physical interface 43 handles adaptation to the type of interface used for the connection to the transmit modem (Ethernet, IP, or ATM).

It will be noted that the advantage of choosing the Internet Protocol (IP) over Ethernet is that this allows the inclusion of optimized routing functions and functions for automatic rerouting in the event of a fault on a connection.

We turn now to a more detailed explanation of the benefits of the padding bits referred to above. To this end, FIG. 10 depicts the traffic variations at a traffic station for 16 simultaneous voice calls, taking periods of silence into account. These variations follow a statistical profile: the probability of the 16 channels being active simultaneously is very low, as is the probability of the 16 channels being silent simultaneously; on average, eight of the 16 channels are active.

The compressor being connected to a satellite transmission system that integrates a DAMA function, satellite resources are assigned at a relatively slow rate, for example every 1.6 seconds, during which period a number of parties will go from being silent to speaking; over the same time period, the number of parties that change from speaking to being silent is not necessarily the same, which explains the supplementary margin of almost 50% between assignment of channels by the system to the traffic station concerned and the channels actively used thereby. Because the resource assignment system does not generally take automatic account of a margin, the compressor adds margin bits to simulate occupation of transmission resources over and above its actual requirements. The supplementary bits that are not used to transmit payload data are used for redundancy of the most critical information, for example the state code or frame number. On the other hand, if the decompression device must transmit more elements than in the preceding cycle, it uses the margin bits to transmit them, to the detriment of transmitting redundant information, the state code signaling which new elements are active. This process based on the use of meaningful margin bits smoothes the load on the connection used and thus adapts the compression/decompression device of the invention of the priority application to the inertia of the resource assignment mechanism conventionally used, whilst avoiding the transmission of bits with no utility. It is to be noted that the shorter the resource assignment cycle, the smaller this margin can be. If this margin is reduced to the point that it is not possible to transmit a state code or a complete frame number, one advantageous solution is to multiplex this redundant information onto a plurality of consecutive data blocks, spacing the cyclic repetitions of this information by a repetition boundary indicator and considering the information multiplexed in this way to apply to the block carrying the repetition boundary indicator.

The role of the DAMA function being to share the assigned band dynamically as a function of the current requirements of each station, considering N stations with a balanced current traffic, for simplicity, with 16 calls at each station, a considerable statistical multiplexing saving is obtained if N is relatively high (at least 10).

This is because, if N=1, the resources reserved for the 16 calls are strictly equal to what is needed for the 16 calls, that is to say 16×16 kbps (a call requiring 16 kbps at the A-bis interface). On the other hand, for a high value of N (greater than 10), the ideal case is approximated, corresponding to the theoretical sufficiency of reserving 50% of the total band for a station, that is to say 8×16 kbps per station, or 10×8×16 kbps for all ten stations for a given direction, or double this quantity for the two directions.

Rather than reserving resources statically for each station, resources are assigned dynamically.

With the compressor/decompressor of the invention of the priority application, the function for detecting the activity of nibbles is used to inform the resource management center 10 of the current requirements of the stations. In the present context, there is an assignment of resources every 1.6 seconds and the current assignment of resources is based on the traffic statistics for the preceding 1.6 second cycle.

On the basis of this current requirements information supplied by the compressor/decompressor of the invention of the priority application, the resource center artificially increases the size of the packets transmitted by adding supplementary bits in each transmitted packet to achieve a sufficient resource margin.

For example, if the current requirement of a station is to transmit 50 bytes every 2.5 ms, ten supplementary bytes are added for example so as not to lose nibbles in transmission if the number of active nibbles detected increases by 20% before the next assignment of resources. If this precaution of reserving a supplementary margin is not taken, the transmit modem used for transmission saturates and rejects excess packets that it cannot transmit given the transmission capacity assigned to it for the current cycle.

The information content of the supplementary bits forming said supplementary bytes that complete the transmission packets can be of two types:
either padding information, not pertinent to the transmission of data, and intended only to serve as a bit rate margin for the reasons cited hereinabove,
or payload information, intended to repeat the data that is the most critical for the transmission: state code, frame number and where applicable header bits.

The two types of information may be combined.

It will be noted that repeating the state code may prove to be highly pertinent in that the loss or incorrect reception of the state code by the destination equipment could disrupt the frame reconstruction process, which would lead to a shifting of the nibbles within the reconstructed frame.

The process just described is referred to as level 1 compression. Level 2 compression complements it using identical signaling and a state code analogous to the state code described for level 1. It operates by identifying the type of content conveyed by the transmission channel concerned. Each call is time division multiplexed at the rate of one nibble per frame, for a 16 kbps compressed channel. This time division multiplex is itself structured in frames, for example frames of 320 bits every 20 ms. During a call, a party is alternately active and silent. In a manner that is not specific to the device discussed here, during periods of silence, the transmission of frames is continued but an indicator within the frame signals that this frame is non-active. The level 2 compression exploits this indicator to suspend the transmission of data relating to the compressed voice and transmit only the payload elements of the frame of 320 bits. During the transmission of payload information, the bit corresponding to the position of the element concerned in the input frame of the compression device is active within the level 2 state code and is reset to the inactive state as soon as this payload information has been transmitted. This increases the efficiency of the level 1 compression device by extending it to interpret elements that are not static but comprise data that is not useful.

FIG. 11 depicts in detail a decompression device or decompressor 302 of one embodiment of the invention of the priority application. An input connected to the receive modem 31 is connected to a physical interface 45 for adapting the frames (Ethernet, IP, or ATM) to the format of the data blocks compressed by the compression method of the invention.

This interface 45 is connected at its output to the input of an FIFO buffer register 46 for storing the received data blocks.

A first output of the register 46 is connected to an extractor 47 for extracting the frame number 444 and a second output is connected to means 48 for inserting active elements of the current frame and a third output of the register 46 is connected to a state code detector 49.

A frame counter 50 internal to the decompressor is initialized when the connection is set up, with a negative offset vis a vis the number of the received frame. This is intended to prevent famine caused by a received frame delay vis à vis the value of the counter.

A comparator 501 compares the frame number value in the extractor 47 and the, counter 50. If the value in the counter and the frame number associated with the block in the buffer register 46 are the same, the comparator commands a memory 51 that contains the preceding frame to supply it to an input of the insertion means 48.

The state code detector 49 detects the state code associated with the received data block and supplies it to the input of a state register 52 whose output is connected to another input of the insertion means 48.

Finally, the register 46 supplies the received data block to a third input of the insertion means 48. Thus if the frame number and-the number in the frame counter are the same, the insertion means 48 reconstitute the current frame by repeating the preceding frame from the memory 51 and replacing the elements signaled as active by the values contained in the received data block, on the basis of information signaling the positions of the active elements supplied by the state register 52.

The reconstituted frame is then supplied to a physical interface 53 that adapts the data blocks to the format of the frames conveyed over the A-bis interface.

It is particularly important to note that the invention of the priority application can encompass higher data levels, as explained hereinafter:

The data conveyed within the frames to be compressed is generally itself encapsulated within frames having a proprietary or non-proprietary format. The compression/decompression method can encompass the compression of the data within the frames, in accordance with the same principle. The objective of this is to improve compression further by eliminating all superfluous data.

One example is the encapsulation of a 9.6 kbps user voice channel in a 16 kbit frame by adding synchronization, padding and signaling bits. The additional compression method suppresses the synchronization and padding bits and retains only the signaling bits (state codes, etc), which have a dynamic character, in the sense previously explained for active element detection.

The reconstitution of the original frames is synchronized implicitly, by detecting the boundary between the transmitted data blocks.

An embodiment of the compression/decompression method of the invention of the priority application comprising an automatic change to an uncompressed mode is described hereinafter and is of particular advantage:

The bandwidth saving is evaluated continuously. Immediately the bit rate of the average output data stream from the nibble compressor exceeds that of the average input stream, the compression device is bypassed, synchronously and at a frame boundary, and an indicator is transmitted to the decompressor to deactivate the decompression mechanism on the decompressor side. Conversely, as soon as the 10 bit rate of the average compressed data stream drops below a certain threshold relative to the incident data stream, the compression/decompression device is reactivated.

The threshold is intended to avoid inopportune switching from the compressed mode to the non-compressed mode, in particular if the load of the 15 frames to be transmitted is close to saturation.

The following dispositions may be applied individually or in combination to prevent disturbance of the satellite link, which could be reflected in a loss of information, degrading of the information transmitted, or even addition of interfering information, and thus disturbance of the reconstitution of the frames:
automatic change to the non-compressed mode immediately the quality of the connection becomes critical (detected by monitoring the E_{b}/N₀ or the BER), and/or using error detection based on the CRC associated with each Ethernet frame, for example,
adding cyclic redundancy codes to the most critical information, in particular the state code, with the intention of securing the correct recovery of that information,
repeating the state code,
systematically sending the state code as soon as the quality of the connection drops below a certain threshold or as soon as an error is detected (frame number sequence error or CRC error),
sending the state code more often if the quality of the connection is being degraded,
monitoring the frame number associated with the received data block, in order to detect sequence breaks associated in particular to a loss of frame, and analyzing the next frame number in order to correct a transitory frame number error.

The prior art Intelsat Business Services (IBS) framing scheme is used to transmit via satellite the type of frame structure depicted in FIG. 6. IBS framing transmission is very widely used, as it can transmit N×64 kbps, N being established as a function of the real requirement of the network operator. However, IBS modems do not integrate a function for dynamically varying the N×64 kbps bit rate as a function of the content to be transmitted.

In one embodiment, the compression device 30 splits the traffic between two or more of its outputs, each output offering a fixed bit rate, activated as a function of the load after compression by the compressor 301 using the method described hereinabove. Immediately the compressed bit rate exceeds the bit rate reserved on the first channel, for example 5×64 kbps, a portion of the traffic is offloaded onto a second channel, for example at 2×64 kbps, and as soon as this second channel is saturated in its turn, the second channel is switched to a third channel, at 4×64 kbps, for example, and so on in this manner, switching the additional traffic between channels 2 and 3 without interrupting transmission but offloading the traffic from the permanent channel to the additional channel constituted in this way.

At the receiver, the original frames are reconstituted by concatenating the blocks of data received via the main channel and via the additional channel.

FIG. 12 depicts a variant 303 of the decompression device 302 from FIG. 11 that can advantageously also be used in any public or private IP network. The advantageous functions in this case are: level 1 and level 2 data compression/decompression, frame number addition, decompression with resynchronization of the frames at the output, and specific processing in the event of non-reception of the compressed frame at the time it should be reconstituted.

The data blocks 44 enter the decompressor 303 via an input 3030. A frame number extractor 304 extracts the identifying numbers from each frame. The blocks 44 are also supplied to a data block memory (305). FIG. 12 depicts six data blocks characterized by their frame numbers 444, each depicted by a shaded box. The first compartment of each block represents the state code 442 of the block and the subsequent compartments correspond to the compressed data 441.

A dashed line A in FIG. 12 surrounds in particular the portion common to FIG. 11 for reconstituting the original frames. As this has been described and explained already, there is no need to do so again here.

Furthermore, the device 303 comprises a counter initialization circuit 307 receiving the number of the current frame and the number of data blocks stored in the memory 305.

When the decompression device is initialized, the circuit 307 initializes the counter 50, synchronizing it with the first frame number received by the decompressor.

Furthermore, synchronization by the initialization circuit is repeated on subsequent repeated detection of a discrepancy between the frame numbers received and the current output of the counter.

The process is as follows: the decompressed frames are stored in the memory 305 of the decompression device for as long as the respective frame number associated with them is not identical to the frame number supplied by the local frame counter, allowing for a negative offset, to provide some flexibility in the reconstitution of frames and to compensate time fluctuations induced by the transmission system, which often occur in the event of transmission via satellite or in terrestrial networks, in particular IP networks, whereas the frames are deemed to be reconstituted at a constant and invariant rate. As soon as the comparator 501 establishes identity, the frame for which identity has been established is therefore applied at the output of the decompression device.

If no frame corresponds to the number of the frame to be reconstituted at the output of the decompression device, the preceding frame is repeated and/or an error code is generated by an absence of frames signaling generator 307 and sent to a telecommunication system management center (not shown).

If the error consisting in a difference between the current frame number and the frame number supplied by the local frame counter of the decompression device is repeated over a plurality of consecutive frames, the local frame counter is resynchronized to the received frame identifiers.

The negative offset applied at the output of the frame counter is intended to establish a margin covering the range of time fluctuations induced by the satellite transmission system.

The FIG. 12 schematic shows that, instead of using an FIFO, as in the FIG. 11 embodiment, a buffer is used to reschedule the received data blocks on the basis of the block number associated with each data block, which is shown in the filled-in boxes, the initialization circuit initializing the counter on start-up or each time a repeated sequence break occurs.

The local counter is initialized as a function of statistics on variation in the number of blocks present in the buffer, setting the minimum value so that it is always greater than 1, allowing for an additional margin, and less than the capacity of the buffer expressed as a maximum number of blocks.

If the number of blocks stored reaches the size of the buffer expressed as a maximum number of blocks, the generator 306 generates an alarm, signifying detection of abnormal behavior of the network (excessive time fluctuations).

This embodiment of the decompression device therefore has the advantage of being able to receive data blocks out of sequence, thanks to the memory 305, and of being able to support transmission delay fluctuations, thanks to the offset introduced.

What is described hereinafter is directly related to the spirit of the invention of the present application.

The present invention consists in an analyzing the content of each channel (carried by two bits in the previous embodiments, but which may be conveyed by one bit or by two, four or eight bits, depending on the transmission mode, without this being limiting on the invention); if the channel analyzed consists of the consecutive repetition of a reference pattern or reference window throughout an analysis window, it is compressed; for example, for a reference pattern on four bits, corresponding to the state of the bit concerned during the last four frame preceding the current analysis window:
if the reference frame equals 1011, for example,
the channel is compressed if, during the analysis window, the successive content of the channel concerned (coded on one bit in this instance) is equal to:
abcdabcdabcdabcd
   if at least one bit differs from the cyclic repetition of the reference pattern, the channel is considered to be active, i.e. non-static, and its content is transmitted in its entirety for the current analysis window; for a compressed channel, no data is transmitted except for an active channel descriptor (ACD), which identifies the position of the active channels within the frame to be reconstituted. The ACD is also referred to as the state code (denoted by reference number 442 in the preceding embodiment from the priority application).

Consequently, instead of being based on the state of a single bit per channel to detect the change to the static state, the state of the bit during the last N frames preceding the current analysis window is used.

FIG. 13 depicts one embodiment of the compression method with N=4.

Note that the first two channels of the analysis window 70 are repeated with a period of four consecutive frames, in exactly the same way as the reference pattern 71 consisting of the state of the channel during the last four frames preceding the current analysis window 70. A decision is then taken to compress the repeated pattern.

The compressor 301′ according to the invention, depicted in FIG. 14, is analogous to the compressor 301 from FIG. 7, except for a memory 34′ for storing L*N current frames forming the analysis window 70 and a memory 35′ for storing N frames preceding the analysis window forming the reference pattern.

Similarly, the device 302′ in FIG. 15 is analogous to that in FIG. 11, except that the memory 51 of the latter is replaced by a memory 51′ for storing the reference pattern (the last four data frames preceding the current compressed frame).

The method is then identical to the method of the priority application explained above:
at the compressor end, suppression of the static channels from the current window, transmission to each analysis window of the state code ACD specifying the position of each active channel within the input frame, followed by the concatenated content of each active channel;
at the decompressor end, extraction/detection of the state code ACD by the detector 49, followed by restitution of the structure of the uncompressed frame by insertion of the content of each active channel at the position specified by the state code ACD, with repetition for each static channel of the content of its corresponding static bit taken from the reference pattern (new process, instead of retaining the reference bit of the static channel concerned), by virtue of comparing/storing the content of the last N frames preceding the change of the channel to the static state. Note that the block 40 also receives the reference pattern. The function of the block 40 is to transmit the reference pattern periodically between two data blocks 44′.

There is explained next a particularly advantageous aspect of the invention that responds to the need to secure the process of recovering concatenated channels transmitted in serialized form.

This is because a problem may arise following a serialization or sequencing error reflected in an offset of the transmitted data, to the right if channels declared non-active have been inserted erroneously, or to the left if channels declared active have not been inserted.

FIG. 16 depicts a frame structure 44′ compressed by the compression method of the invention from a set 500 of NT frames E1 and which supplies at the decompression end of the system the NT frames E1:

This structure begins conventionally with at least one synchronization bit 446 and ends with padding bits 447.

If the device is operating correctly, the number of bits in the concatenated active channels (CAC) field 441′ is equal to the number of bits at 1 in the state code, characterizing the position of the active channels within the input frame, multiplied by the number NT of incoming frames in the analysis window.

For example, if ACD has the binary value 0101 1101, in which five bits are at 1, indicating that five channels are active for the current analysis window, and if NT=16, indicating that the analysis window applies to 16 input frames at the level of the compressor, then the number of bits in the CAC field is equal to 5×NT=AT bits; the device compares the eight bits of the frame received, situated 80 bits after the end of the CRC ACD 445; if no formatting or transmission error has occurred, the field obtained in this way is equal to the value established for a delimiter 448 immediately following the CAC.

However, the delimiter that fixes the boundary between the concatenated active channels field and the padding bits may be shifted relative to the position it is deemed to occupy.

A number of errors may be induced by binary errors induced at the level of the ACD, the CRC ACD, or the delimiter.

To detect and deal with this situation, which would result in a decompression error, various actions are undertaken; they are all based on analyzing the content of the delimiter of the received compressed frame (immediately after the concatenated active channels field as processed on the basis of the received ACD), and on the use of the cyclic redundancy code (CRC ACD), for detecting an error in the transmission of the ACD (or in the CRC associated with the ACD).

The delimiter has a fixed value that is set at the compressor end, and is equal to 1111 0000, for example.

All these situations are processed successively by calculating the CRC associated with the ACD, comparing the calculated CRC with the received CRC ACD, and comparing the field received, after the concatenated active channel field, with the value set for the delimiter, using the following process:
normal situation: if the CRC ACD and the delimiter are correct, then decompression is effected using the received ACD;
if the CRC ACD is incorrect but the delimiter is correct, then a CRC ACD error is declared, and decompression is effected using the received ACD;
if the CRC ACD is correct but the delimiter is incorrect, then a delimiter error is declared, and decompression is effected using the received ACD;
if the CRC ACD and the delimiter are both incorrect, a test is carried out to detect if the field of the delimiter is correct, based on the ACD of the preceding compressed frame (channel activity changes are generally much less frequent than the period of the compressed frames); if the test result is positive, then an ACD error is declared and decompression is effected using the ACD of the preceding compressed frame; if the test result is negative, then a decompression error is declared and decompression is suspended and empty frames are output.

Of course, the present invention is not limited to the embodiments described and the person skilled in the art may readily envisage other embodiments of the invention.

1. Data compression device (301′) for compressing a set (500) of current data frames (60) of a data stream, these frames having a structure defined by a plurality of time slots, first group of time slots being such that each is decomposed into a plurality of elements carrying respective communication channels,
characterized in that said compression device comprises:
means (40) for transmitting a reference pattern comprising the N frames preceding the set (500) of current frames, where N is an integer greater than or equal to 1,
means (36, 361, 362, 363) for analyzing the active or static state of at least one channel contained in an analysis window (70) of the current frames (60), the active, respectively static, state of this channel being assigned to it if the comparison of the content of this channel in the N bits compared between the N frames of a reference pattern (71) with the corresponding N bits of the N frames of the analysis window indicates a variation of content for at least one of the bits, respectively a stability of the content for all of the N bits,
extraction means (37, CAC) for extracting the content of the active channels from the analysis window a function of the active states of the elements supplied by said analysis means,
location means (41, ACD) for supplying indications of the locations of said active and static elements in the current frame as a function of the active and static states of the elements supplied by said analysis means, and
grouping means (40) for grouping at least one identifier of the current block, the content of the active elements, and their respective locations within a data block (44) to be transmitted.

2. Device according to claim 1, characterized in that it comprises first memory means (34′) for storing N frames preceding the current analysis window forming the reference pattern.

3. Device according to claim 1, characterized in that it comprises second memory means (35′) for storing current frames (60) forming the analysis window.

4. Device according to claim 1, characterized in that the analysis window has a length of L*N frames, where L≧1, so that the bits are grouped into blocks (700) of N bits thereby forming L blocks of N bits and in that for each spatially corresponding bit within the L block in succession, the repetition of the same content leads to an inactivity decision in respect of the block of N bits.

5. Device according to claim 1, characterized in that it comprises frame identification means (39) for supplying an identifier (444) specific to each compressed frame.

6. A device according to, characterized in that said location means comprise generation means (41) for generating a state code signifying respective states of said elements of the input frames.

7. A. device according claim 1, characterized in that said analysis means (36, 361, 362, 363) comprise comparison means (361) for comparing the content of the analysis window with that of the reference pattern, detection means (362) for detecting state variations as a function of said comparison, and determination means (363) for determining the active or static state of each element, respectively the N bit blocks.

8. A device according to claim 7, characterized in that the analysis window has a length of L*N frames, where L≧1, so that the bits are grouped into blocks (700) of N bits thereby forming L blocks of N bits and in that for each spatially corresponding bit within the L block in succession, the repetition of the same content leads to an inactivity decision in respect of the block of N bits, and further characterized in that the determination means (363) comprise third storage means (3631) for storing a number L corresponding to the number of N-width bit blocks to be considered before an element is identified as changing from the active state to the static state.

9. A device according to claim 1, characterized in that it comprises fourth storage means (42) for storing a plurality of data blocks (44) before sending.

10. A device according to claim 1, characterized in that said grouping means comprise a padding data manager (401) for managing data to be transmitted in complementary fashion in the block (44) relative to the data contained in said first group of time slots.

11. A device according to claim 1, characterized in that it comprises a plurality of outputs for transmitting data blocks (44), each output offering a predetermined bit rate, the device being pre-programmed to direct data blocks selectively to the outputs according to their respective bit rate saturation level.

12. A device according to claim 1, characterized in that it comprises a fixed bit rate first output and a variable bit rate output for receiving the data block.

13. A device according to claim 11, characterized in that it comprises at least three outputs, a fixed bit rate first output, a fixed bit rate second output that is activated as soon as the bit rate exceeds the capacity of that offered at the first output, and a third output that is activated in place of the second output as soon as the capacity available at the first and second outputs appears insufficient in turn, alternate activation of the first and second outputs increasing, respectively decreasing, in predetermined steps the capacity assigned to the connection to which the compression device is connected as a function of current requirements.

14. A data block comprising a data group (441′) compressed from a set (500) of data frames (60) having a structure defined by a plurality of time slots, a first group of time slots being such that each is decomposed into a plurality of elements each carrying a respective communication channel, characterized in that the active state, respectively the static state, of this channel being allocated to it if the comparison of the content of this channel in the N bits compared between the N frames of a reference pattern (71) for the corresponding N bits of N frames (60) indicates a variation of content for at least one of the bits, respectively a stability of content for all the N bits, the compressed data group (441′) comprises the content of the active channels of the frames (60), and in that the block further comprises an identifier specific to the block and indications of the locations of said active elements in the frames (60).

15. A data block according to claim 14, characterized in that said location indications comprise a state code (442′, ACD) representative of the position of said active elements within the frames (60).

16. A data block, characterized in that the analysis window has a length of L*N frames, where L≧1, so that the bits are grouped into blocks (700) of N bits thereby forming L blocks of N bits and in that for each spatially corresponding bit within the L block in succession, the repetition of the same content leads to an inactivity decision in respect of the block of N bits, and further characterized in that the frame identifier is a frame number (444) modulo the capacity of frame counting means of a data compression device according claim 1.

17. A data block according claim 14, characterized in that the group (441′) of data also includes complementary data to be transmitted in complementary manner in the block (44) relative to the data contained in said first group of time slots.

18. A data block according to claim 17, characterized in that said complementary data comprises padding data for obtaining a safety margin when assigning transmission resources to the connection concerned and/or payload data repeating pertinent data contained in said first group of time slots.

19. A data block according to claim 18, characterized in that the payload data belongs to the group comprising header data, current frame identifier, indications of the locations of said active elements in the current frame, and state code.

20. Data block according to claim 14, characterized in that the compressed data group (441′) is followed adjacently by a delimitation field (448) marking the end of the compressed data group (441′).

21. A data decompression device for decompressing a compressed data block (44′), said data block comprising a data group (441′) compressed from a set (500) of current data frames (60) having a structure defined by a plurality of time slots, a first group of time slots being such that each is decomposed into a plurality of elements carrying respective communication channels, characterized in that it comprises fourth storage means (51′) for storing a received reference pattern comprising the N frames preceding the current compressed data block, where N>1,
and it being understood that the active, respectively static, state of this channel is assigned to it if the comparison of the content of this channel in the N bits compared between the N frames of the reference pattern (71) with the corresponding N bits of the N frames of the analysis window indicates a variation of content for at least one of the bits, respectively a stability of content for all of the N bits, the decompressor comprises:
detection means (49) for detecting indications of the locations of the active elements of the data group (441′) in a group of data (441′) of the block (44′), fifth storage means (52) for storing said active element location indications, insertion means (48) for inserting the detected static and active elements as a function of their respective indicated location, so as to form the current frames.

22. A method of managing bandwidth resources in a telecommunication system transmitting data blocks (44′) between traffic stations via satellite, such a data block comprising a data group (441′) compressed from a set of data frames (60) having a structure defined by a plurality of time slots, a first group of time slots being such that each is decomposed into a plurality of elements carrying respective communication channels, and said system comprising a management center (10) for managing said resources, characterized in that said system being provided, for at least one station, with analysis means (36, 361, 362, 363) for analyzing the active or static state of N bits contained in an analysis window (70) of the current frames, where N≧1, the active, respectively static, state of this channel being assigned to it if the comparison of the content of this channel in the N bits compared between the N frames of a reference pattern (71) with the corresponding N bits of the N frames of the analysis window indicates a variation of content for at least one of the bits, respectively a stability of content for all the N bits, the method comprises, at the management center, the steps of:
receiving information representative of the analyzed active channels of at least one data block (44′), and
assigning resources for the station as a function of said information.

23. A resource management method according to claim 22, characterized in that the information transmitted representative of the active elements originates from a request for resources sent from said at least one station to the management center, whereby the transmission resources of the station are varied each time that an element goes from the active state to the static state, or vice-versa.

24. A resource management method according to claim 22, characterized in that the step of receiving information representative of the analyzed active elements follows a step of detecting active elements on the transmission link of the station in the system.

25. A resource management method according to any of claims claim 22, characterized in that the step of assigning resources consists in determining a data block size and/or a transmission period conferred on the station that is a function of said information and allows transmission of at least the active elements.

26. A resource management method according to any of claims claim 21, characterized in that the step of assigning resources for the station is effected as a function of said information, on the basis of which a supplementary margin between the number of active elements and the magnitude of the resources assigned to each connection of the stations of the system is opportunely taken into account.

27. A resource management method according to any of claims claim 22, characterized in that said system comprises a complementary data manager (401) adapted to add complementary data to the connection set up for said at least one station, thereby providing it with a resource margin.
